(19) United States
(12) Patent Application Publication
(10) Pub. No.: US 2008/0129419 A1
(43) Pub. Date: Jun. 5, 2008

(54) Dual-mode dual-ring band-pass filter

(76) Inventors: Chin-Shen Cheng, Hsinchu City (TW); Ji-Chyun Liu, Dasi Township (TW); Pao-Kuei Horng, Longtan Township (TW); Chung-Sen Wu, Lontan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/633,446

(22) Filed: Dec. 5, 2006

(51) Int. Cl. H01P 1/203

(52) U.S. Cl. 333/204; 333/219

(57) ABSTRACT

The present invention relates to a dual-mode dual-ring band-pass filter, which includes a first half-ring resonator, a second half-ring resonator, and a third half-ring resonator. The second half-ring resonator is located inside the opening of the first half-ring resonator. Both ends of the second half-ring resonator connect to both ends of the first half-ring resonator, respectively. Both ends of the third half-ring resonator connect to the both ends where the first half-ring resonator connects with the second half-ring resonator, respectively. In addition, the opening of the third half-ring resonator faces the opening of the second half-ring resonator.

### FIELD OF THE INVENTION

The present invention relates generally to a band-pass filter, and particularly to a dual-mode dual-ring band-pass filter.

### BACKGROUND OF THE INVENTION

With advancement of technologies, the sizes of various novel electronic devices, such as ring resonators, shrink as well. Ring resonators are usually applied in band-pass filters due to their small volume, low price, high quality, and low radiation loss. FIG. 1 shows a structural schematic diagram of a dual-mode dual-ring band-pass filter according to the prior art. As shown in the figure, a traditional dual-mode dual-ring band-pass filter includes a ring resonator 10, and connects to a first coupling capacitor C_{C1} and a second coupling capacitor C_{C2}. The circumference of the dual-mode dual-ring band-pass filter is designed according to an integer multiple of the corresponding wavelength of the central frequency f₀. Because the bandwidth of such a dual-mode dual-ring band-pass filter is quite limited, a perturbation source is used at appropriate locations, for example, at 45-degree and at 135-degree, to perform perturbation for producing dual-mode characteristics. Thereby the bandwidth of the band-pass filter is increased (as shown in FIG. 2). However, the increase is still limited. Therefore, its development in wideband wireless system is limited accordingly. The bandwidth percent of a dual-mode dual-ring band-pass filter in the prior art is less than 10%.

FIG. 3 shows a structural schematic diagram of a dual-mode dual-ring band-pass filter according to the prior art. Based on the reason described above, the band-pass filter used today is mostly a dual-mode dual-ring band-pass filter, which includes a first ring resonator 20 and a second ring resonator 30. The first ring resonator 20 is located inside of the second ring resonator 30. The first ring resonator 20 and the second ring resonator 30 connect to each other by two coupling ends 22, 24. The second ring resonator 30 connects to a first coupling capacitor C_{C1} and a second coupling capacitor C_{C2}. The circumference of the first ring resonator 20 is an integer multiple of the corresponding wavelength of a frequency f_{L}, while the circumference of the second ring resonator 30 is an integer multiple of the corresponding wavelength of a frequency f_{H}. Thereby, as shown in FIG. 4, the bandwidth percent is increased. However, the bandwidth still cannot satisfy the demands by modern wireless systems.

Thereby, a dual-mode dual-ring band-pass filter according to the present invention is proposed for solving the problems described above. The drawback of a narrow bandwidth in a traditional band-pass filter can be improved. In addition, the cost and the occupied area of a band-pass filter can be saved.

### SUMMARY

The purpose of the present invention is to provide a dual-mode dual-ring band-pass filter, which uses three half-ring resonators to increase bandwidth.

Another purpose of the present invention is to provide a dual-mode dual-ring band-pass filter, which uses three half-ring resonators to form a dual-mode band-pass filter. Thereby, the purposes of small volume, small-occupied area, and low cost can be achieved.

The dual-mode dual-ring band-pass filter according to the present invention includes a first half-ring resonator, a second half-ring resonator, and a third half-ring resonator. The second half-ring resonator is located inside the opening of the first half-ring resonator. Both ends of the second half-ring resonator connect to both ends of the first half-ring resonator, respectively. Both ends of the third half-ring resonator connect to the both ends where the first half-ring resonator connects with the second half-ring resonator, respectively. In addition, the opening of the third half-ring resonator faces the opening of the second half-ring resonator.

### BRIEF DESCRIPTION OF THE DRAWINGS

FIG. 1 shows a structural schematic diagram of a dual-mode dual-ring band-pass filter according to the prior art;

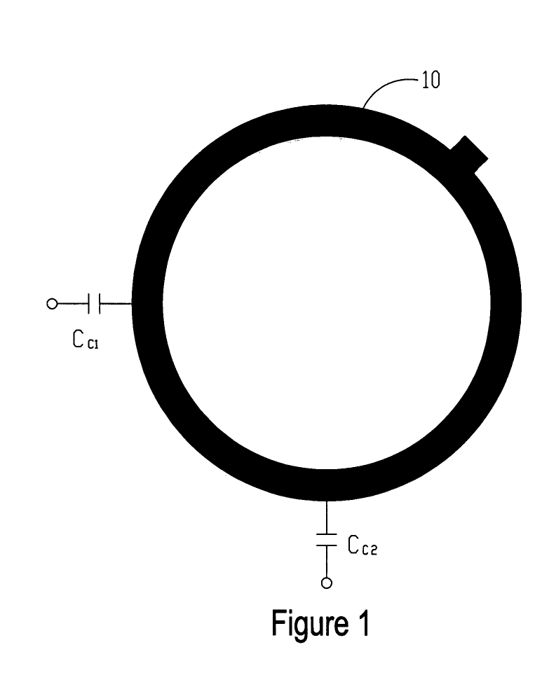

FIG. 2 shows a spectrum diagram of a dual-mode dual-ring band-pass filter according to the prior art;

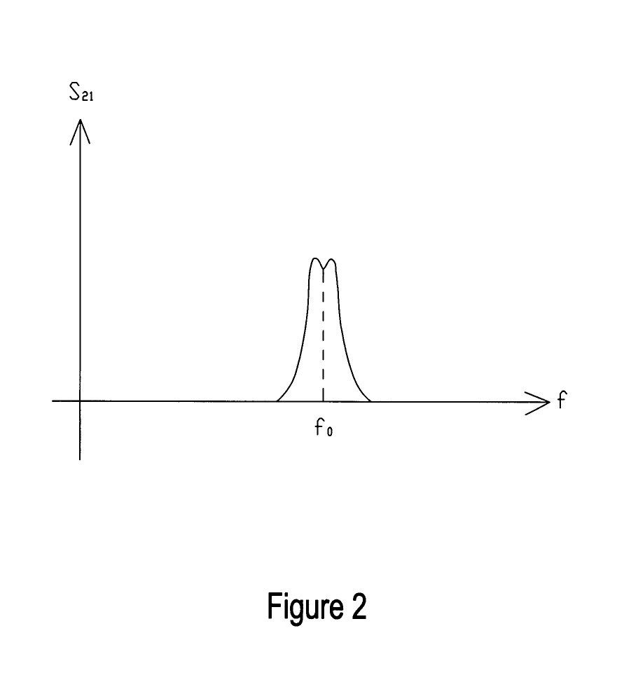

FIG. 3 shows a structural schematic diagram of a dual-mode dual-ring band-pass filter according to the prior art;

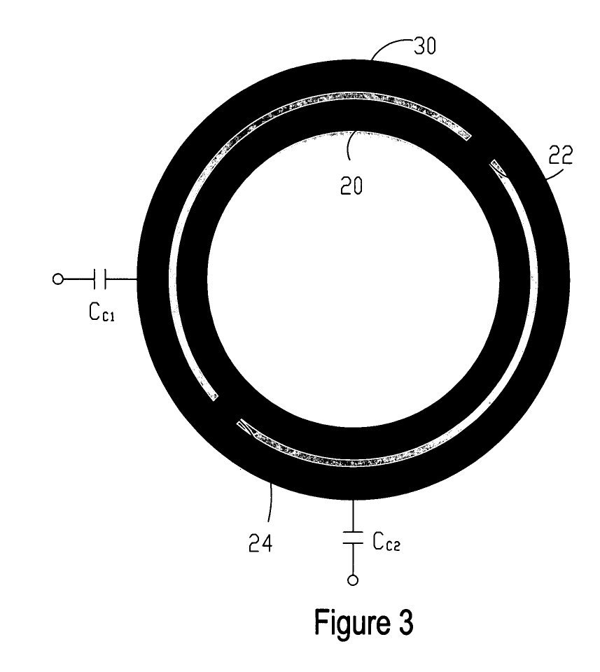

FIG. 4 shows a spectrum diagram of a dual-mode dual-ring band-pass filter according to the prior art;

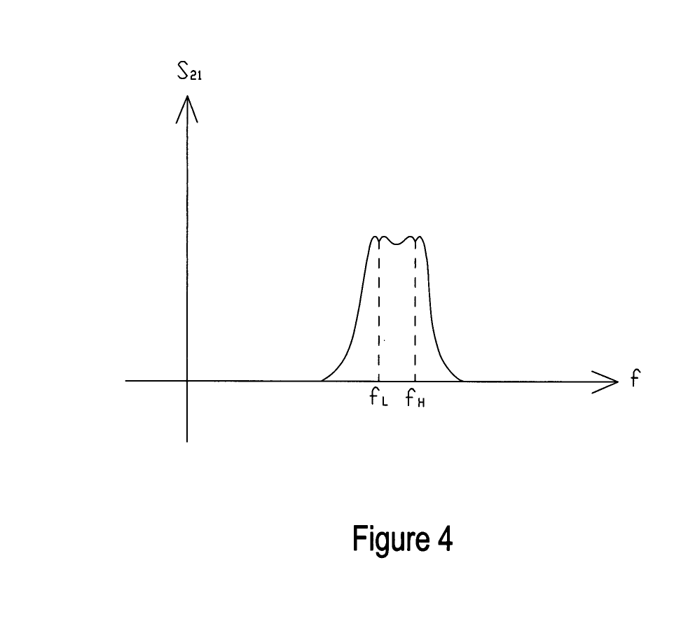

FIG. 5 shows a structural schematic diagram of a dual-mode dual-ring band-pass filter according a preferred embodiment of the present invention; and

FIG. 6 shows a spectrum diagram of a dual-mode dual-ring band-pass filter according a preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

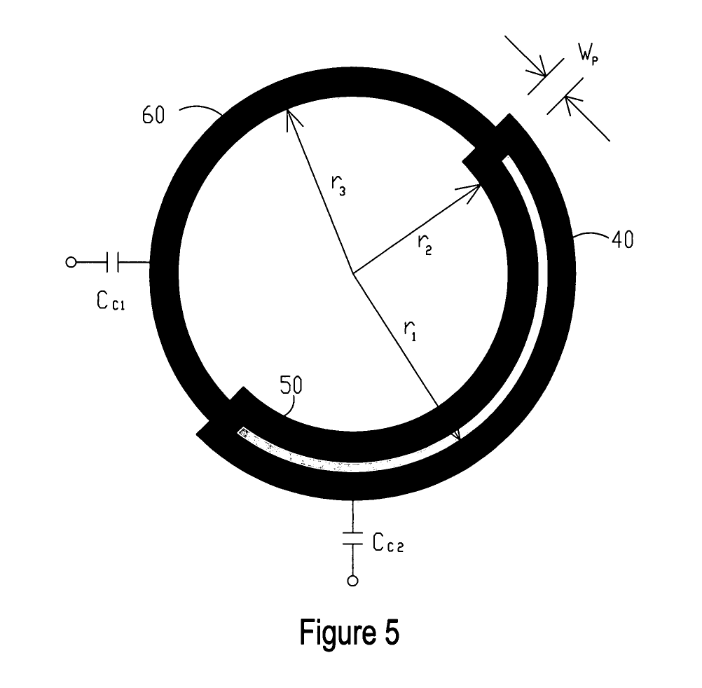

FIG. 5 shows a structural schematic diagram of a dual-mode dual-ring band-pass filter according a preferred embodiment of the present invention. As shown in the figure, the present invention includes a first half-ring resonator 40, a second half-ring resonator 50, and a third half-ring resonator 60. The second half-ring resonator 50 is located inside the opening of the first half-ring resonator 40. Both ends of the second half-ring resonator 50 connect to both ends of the first half-ring resonator 40, respectively. In addition, the opening of the third half-ring resonator 60 faces the opening of the second half-ring resonator 50. Besides, both ends of the third half-ring resonator 60 connect to the both ends where the first half-ring resonator 40 connects with the second half-ring resonator 50, respectively.

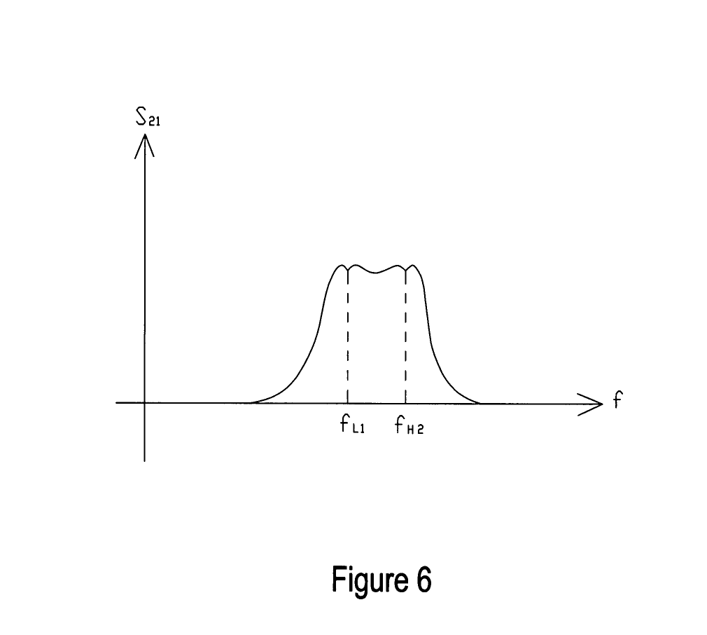

Continued form the above description, the radius r₁ of the first half-ring resonator 40 is greater than the radius r₂ of the second half-ring resonator 50. The radius r₃ of the third half-ring resonator 60 is greater than the radius r₂ of the second half-ring resonator 50, and is smaller than the radius r₁ of the first half-ring resonator 40. The sum of the circumference of the first half-ring resonator 40 and the circumference of the third half-ring resonator 60 corresponds to a first frequency f_{L1}, while the sum of the circumference of the second half-ring resonator 50 and the circumference of the third half-ring resonator 60 corresponds to a second frequency f_{H1}. That is to say, the sum of the circumference of the first half-ring resonator 40 and the circumference of the third half-ring resonator 60 is an integer multiple of the corresponding wavelength of the first frequency f_{L1}, while the sum of the circumference of the second half-ring resonator 50 and the circumference of the third half-ring resonator 60 is an integer multiple of the corresponding wavelength of the second frequency f_{H1}. The second frequency f_{H1} described above is greater than the first frequency f_{L1} (as shown in FIG. 6). Moreover, the outer circumference of the first half-ring resonator 40 further connects to a second coupling capacitor C_{C2}, and the outer circumference of the third half-ring resonator 60 connects to a first coupling capacitor C_{C1}.

FIG. 6 shows a spectrum diagram of a dual-mode dual-ring band-pass filter according a preferred embodiment of the present invention. As shown in the figure, the bandwidth of the dual-mode dual-ring band-pass filter according to the present invention is greater the bandwidth of the dual-mode dual-ring band-pass filter composed of two full-ring resonators according the prior art. The bandwidth percent of the dual-mode dual-ring band-pass filter according to the present invention is over 28%. According to the present invention, a plurality of the dual-mode dual-ring band-pass filters can be connected in series for achieving better performance. In addition, according to the present invention, by adjusting a coupling width W_{P} of the first half-ring resonator 40 and the second half-ring resonator 50, the bandwidth can be adjusted to satisfy usage requirements.

The dual-mode dual-ring band-pass filter composed of three half-ring resonators 40, 50, 60 according to the present invention has high Q-factor and high efficiency, thereby is suitable for microwave communication apparatuses and wireless communication systems such as Wireless Local Area Networks (WLAN) and Ultra Wide Band (UWB) systems. Besides, the present invention is suitable to be adapted on printed circuit boards, integrated circuits, and Low Temperature Cofired Ceramic (LTCC). By comparing the dual-model dual-ring band-pass filters according to the present invention and according to the prior art, the present invention uses only three half-ring resonators to form the dual-model dual-ring band-pass filter, while the dual-model dual-ring band-pass filter according to the prior art uses two full-ring resonators, which are equivalent to four half-ring resonators. Accordingly, the volume occupied by the present invention is smaller, and hence the occupied area is smaller. Furthermore, the manufacturing cost is lower.

To sum up, the dual-mode dual-ring band-pass filter according to the present invention includes a first half-ring resonator, a second half-ring resonator, and a third half-ring resonator. The second half-ring resonator is located inside the opening of the first half-ring resonator. Both ends of the second half-ring resonator connect to both ends of the first half-ring resonator, respectively. Both ends of the third half-ring resonator connect to the both ends where the first half-ring resonator connects with the second half-ring resonator, respectively. In addition, the opening of the third half-ring resonator faces the opening of the second half-ring resonator. By using the three half-ring resonators, the bandwidth of the dual-mode dual-ring band-pass filter is increased, the occupied area is reduced, and the manufacturing cost is saved.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A dual-mode dual-ring band-pass filter, comprising:
a first half-ring resonator;
a second half-ring resonator, locating inside the opening of the first half-ring resonator, and both ends thereof connecting to both ends of the first half-ring resonator, respectively; and
a third half-ring resonator, both ends thereof connecting to the both ends where the first half-ring resonator connects with the second half-ring resonator, respectively, and the opening thereof facing the opening of the second half-ring resonator.

2. The dual-mode dual-ring band-pass filter of claim 1, and further comprising:
a first coupling capacitor, connecting to the outer circumference of the third half-ring resonator; and
a second coupling capacitor, connecting to the outer circumference of the first half-ring resonator.

3. The dual-mode dual-ring band-pass filter of claim 1, wherein the sum of the circumference of the first half-ring resonator and the circumference of the third half-ring resonator corresponds to a first frequency, while the sum of the circumference of the second half-ring resonator and the circumference of the third half-ring resonator corresponds to a second frequency.

4. The dual-mode dual-ring band-pass filter of claim 1, wherein the second frequency is greater than the first frequency.

5. The dual-mode dual-ring band-pass filter of claim 1, wherein the radius of the third half-ring resonator is greater than the radius of the second half-ring resonator, and is smaller than the radius of the first half-ring resonator.

6. The dual-mode dual-ring band-pass filter of claim 1, wherein the dual-mode dual-ring band-pass filter can be connected in series.

7. The dual-mode dual-ring band-pass filter of claim 1, wherein the dual-mode dual-ring band-pass filter can be adapted on one chosen from the group consisting printed circuit boards, integrated circuits, and Low Temperature Cofired Ceramic (LTCC).

8. The dual-mode dual-ring band-pass filter of claim 1, and being applied to microwave circuits.
